(19) United States
(12) Patent Application Publication
(10) Pub. No.: US 2003/0162951 A1
(43) Pub. Date: Aug. 28, 2003

(54) Yellow disperse dye mixture

(76) Inventors: Ulrich Bühler, Alzenau (DE); Hartwig Jordan, Bergisch Gladbach (DE)

Correspondence Address: CONNOLLY BOVE LODGE & HUTZ, LLP, 1220 N MARKET STREET, P O BOX 2207, WILMINGTON, DE, 19899

(21) Appl. No.: 10/312,711

(22) PCT Filed: Jun. 22, 2001
(86) PCT No.: PCT/EP01/07136

(30) Foreign Application Priority Data
Jun. 28, 2000 (DE) 100 31 567.4

(51) Int. Cl. C09B 56/00

(52) U.S. Cl. 534/653

(57) ABSTRACT

The novel disperse dye mixtures of hydroquinolone monoazo dyes (I)

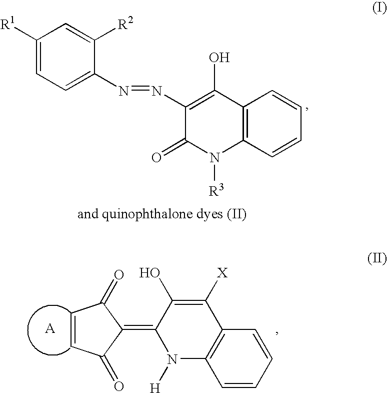

where the substituents are each as defined in the description,

are very useful for dyeing and printing hydrophobic synthetic materials, especially under alkaline conditions.

The present invention relates to novel disperse dye mixtures, preparations containing them and their use for dyeing and printing hydrophobic synthetic materials, especially under alkaline conditions.

Novel disperse dye mixtures have been found that contain at least one hydroxyquinolone monoazo dye of the formula (I) or its tautomeric forms,

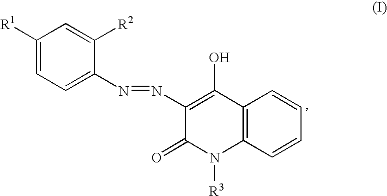

where either

R¹ is PhCO—, in which case the phenyl ring may be substituted by one or more identical or different substituents selected from the group consisting of lower alkyl, preferably straight-chain or branched C₁-C₄-alkyl, and halogen, preferably chlorine or bromine, and

R² is hydrogen,

or

R¹ is NO₂ and

R² is PhCO—, in which case the phenyl ring may be substituted by one or more identical or different substituents selected from the group consisting of lower alkyl, preferably straight-chain or branched C₁-C₄-alkyl, and halogen, preferably chlorine or bromine, and

R³ is H or methyl

and at least one quinophthalone dye conforming to the formula (II) or its tautomeric forms

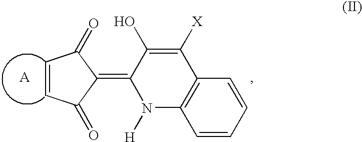

where

X is H or Br and

A is an anellated benzene ring, which may be substituted by lower alkyl, preferably straight-chain or branched C₁-C₄-alkyl, or by halogen, preferably chlorine or bromine, or is an anellated naphthalene ring.

The dyes of the formulae (I) and (II) can occur in tautomeric forms. When reference is made to the formulae (I) and (II), their possible tautomeric forms shall also be comprehended for the purposes of the invention. Possible tautomeric forms to the formula (I) are

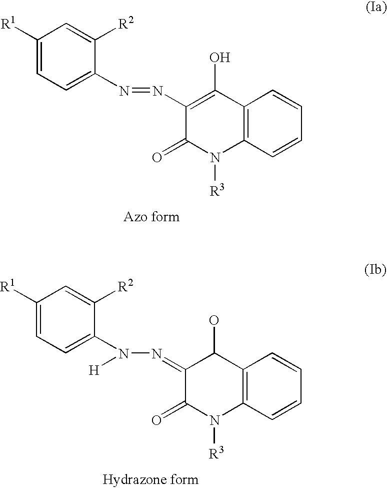

where R¹, R² and R³ are each as defined above.

The quinophthalones (II) have the following possible tautomeric forms:

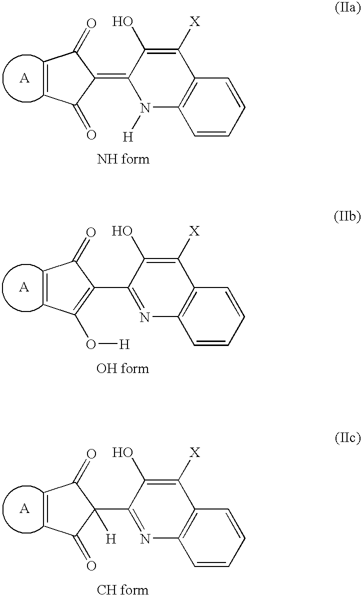

a mixture of the formulae (IIa) and (IIb) being preferred A and X each being as defined above.

The pH symbol in the definitions of R¹ and R² represents unsubstituted phenyl.

Lower alkyl in the definition of R¹, R² and A is to be understood as meaning straight-chain or branched alkyl groups of 1 to 8 carbon atoms.

Straight-chain or branched C₁-C₄-alkyl is to be understood as meaning methyl, ethyl, n- or iso-propyl, n-, iso-, s- or t-butyl.

The amount of the quinophthalones (II) in the mixtures is preferably 10 to 90% by weight, especially 20 to 50% by weight.

Hydroxyquinolone monoazo dyes of the formula (I) where R¹=PhCO and R²=H are known from EP-A 0 752 452, where they are used for dyeing and printing hydrophobic synthetic materials, including in the alkaline medium up to pH 11. Generally the dyeing of polyester in the alkaline range is advantageous, since oligomers of the polyester, which normally foul parts of the dyeing machines, are hydrolyzed, obviating frequent cleaning of the dyeing machines. However, these dyes only have moderate lightfastness.

The quinophthalones (II) are likewise known, from GB-A 1 036 389 (X=Br, A=benzene; Disperse Yellow 64) and also from JP-A 73.08.319 (X =H, A=2,3-anellated naphthalene; Disperse Yellow 160). Disperse Yellow 160 alone is in principle suitable for the alkaline dyeing of polyester, but has the disadvantage that it is very costly and only has moderate build-up capacity. Disperse Yellow 64 has insufficient alkali stability and sublimation fastness.

It has been found that, surprisingly, mixing of the dyes I with quinophthalones of the formula (II) provides dye mixtures which are very useful for dyeing and printing hydrophobic synthetic materials and which can be used in the alkaline range and which moreover lead to very lightfast dyeings, for example on polyester, whose lightfastnesses are superior to what would be expected on the basis of the values for the individual components.

The dyeings with the mixtures according to the invention also have substantially lower catalytic fading, especially when used mixed with blue disperse dyes, compared with the dyeings obtained with the azo dyes alone.

The individual dyes can be prepared in a conventional manner, for example according to the directions in the above-cited patents.

The invention further provides dye preparations which generally contain:

10-60% by weight of dye mixture according to the invention

10-80% by weight of anionic dispersant

0-15% by weight of nonionic dispersant and optionally further additives such as wetting agents, defoamers, dustproofers and also further assistants.

The dye mixtures of the invention and dye preparations containing same can be prepared by various processes. For example by:

a) mixing the separately prepared optionally separately finished individual dyes, preferably prior to the conjoint drying,

b) conjoint finishing of the separately prepared individual dyes.

By finishing is meant the conversion of a generally as-synthesized dye into a form customary for the particular intended use. More particularly, finishing is to be understood as meaning the wet bead milling of the dye in the presence of water, dispersant and optionally further additives and optionally subsequent drying, especially spray drying.

The mixing of the dyes is advantageously effected in suitable mills, for example ball or sand mills, but individually finished dyes can also be mixed by stirring into dyeing liquors. To produce or improve the dispersion of individual dyes or mixtures, the dye mixture to be ground is preferably admixed with one or more dispersants. It will be appreciated that the size of the dye particles can be appropriately influenced by a grinding treatment, for example wet bead grinding, and adjusted to a desired value. Useful dispersants for finishing the dye mixtures of the invention include particular anionic and/or nonionic dispersants. Preference is given to anionic dispersants and particular preference is given to a mixture of anionic and nonionic dispersants.

Useful anionic dispersants include in particular condensation products of aromatic sulfonic acids with formaldehyde, such as condensation products of formaldehyde and alkylnaphthalenesulfonic acids or of formaldehyde, naphthalenesulfonic acids and benzenesulfonic acids, condensation products of substituted or unsubstituted phenol with formaldehyde and sodium bisulfite. Also useful are in particular ligninsulfonates, for example ligninsulfonates obtained by the sulfite or kraft process. Preferably they are products which are partly hydrolyzed, oxidized, propoxylated, sulfonated, sulfomethylated or desulfonated and fractionated according to known processes, for example according to the molecular weight or according to the degree of sulfonation. Mixtures of sulfite and kraft ligninsulfonates are also very effective. Of particular utility are ligninsulfonates having an average molecular weight between 1 000 and 100 000, an active ligninsulfonate content of at least 80% and preferably a low content of polyvalent cations. The degree of sulfonation can vary between wide limits.

Useful nonionic dispersants include for example reaction products of alkylene oxides with alkylatable compounds, for example fatty alcohols, fatty amines, fatty acids, phenols, alkylphenols, arylalkylphenols, carboxamides and resin acids. They are for example ethylene oxide adducts from the class of the reaction products of ethylene oxide with:

a) saturated and/or unsaturated fatty alcohols of 6 to 20 carbon atoms or

b) alkylphenols having 4 to 12 carbon atoms in the alkyl radical or

c) saturated and/or unsaturated fatty amines of 14 to 20 carbon atoms or

d) saturated or unsaturated fatty acids of 14 to 20 carbon atoms or

e) hydrogenated and/or nonhydrogenated resin acids.

Useful ethylene oxide adducts include in particular the alkylatable compounds mentioned under a) to e) with 5 to 30 mol of ethylene oxide.

Useful wetting agents include for example C₆-C₁₀-alkyl phosphates or addition products of C₆-C₁₈-fatty alcohols and ethylene oxide and/or propylene oxide or mixtures of such alkoxylation products.

Useful defoamers include for example tributyl phosphate or 2,4,7,9-tetramethyl-5-decyne-4,7-diol.

Useful dustproofers include for example those based on mineral oil.

Further assistants are to be understood as meaning for example fungicides, for example sodium o-phenylphenoxide or sodium chlorophenoxide, drying preventatives and oxidizers, for example sodium m-nitrobenzenesulfonate, antifreezes or hydrophilicizers, etc.

Preferred solid dye preparations contain:

10 to 50% by weight of dye mixture according to the invention,

10 to 80% by weight of ligninsulfonates, especially kraft and sulfite lignins,

0 to 20% by weight of a condensation product of naphthalenesulfonic acid and formaldehyde,

0 to 10% by weight of a nonionic dispersant, especially addition products of resin acids and ethylene oxide and/or propylene oxide,

0 to 1.5% by weight of wetting agent,

0.1 to 1% by weight of defoamer,

0.2 to 1.5% by weight of dustproofer,

each percentage being based on the total preparation.

Preferred liquid dye preparations contain:

10 to 30% by weight of dye mixture according to the invention,

10 to 30% by weight of ligninsulfonates, especially kraft and sulfite lignins,

0 to 10% by weight of a condensation product of naphthalenesulfonic acid and formaldehyde,

0 to 10% by weight of a nonionic dispersant, especially addition products of resin acids and ethylene oxide and/or propylene oxide,

0.1 to 1% by weight of defoamer,

0.1 to 0.5% by weight of preservative,

0 to 15% by weight of antifreeze, especially glycerol, and

79.8 to 10% by weight of water,

each percentage being based on the total preparation.

Useful preservatives include for example isothiazolidones, for example 1,2-benzisothiazol-3-(2H)-one, chloro-2-methyl-4-isothiazolin-3-one or 2-methyl-4-isothiazolin-3-one, pentachlorophenol sodium, 1,3,5-triethylhexahydro-s-triazine or mixtures thereof.

The dye preparations are very useful for dyeing and printing hydrophobic synthetic materials.

Useful hydrophobic synthetic materials include for example secondary cellulose acetate, cellulose triacetate, polyamides and macromolecular polyesters. The dye mixtures of the invention are preferably used for dyeing and printing materials comprising macromolecular polyesters, especially those based on polyethylene glycol terephthalates or their blends with natural fiber materials, as in particular wool or cellulose.

The dye mixtures of the invention are also useful for dyeing and printing hydrophobic synthetic materials when mixed with other disperse dyes. Preferred disperse dyes for such mixtures are C.I. Disperse Blue 56, C.I. Disperse Blue 165 and C.I. Disperse Blue 367.

The hydrophobic synthetic materials can be present in the form of sheetlike or threadlike structures and have been processed for example into yarns or woven, loop-formingly knitted or loop-drawingly knitted textile fabrics.

The dyeing of the fiber material mentioned with the dye mixtures of the invention and the respective dye preparations is effected in a conventional manner, preferably from aqueous suspension, optionally in the presence of carriers generally at 80 to 110° C. by the exhaust process or by the HT process in a dyeing autoclave at 110 to 140° C. and also by the thermofix process, whereby the material is padded with the dye liquor and subsequently fixed at about 180 to 230° C. This provides very strong greenish yellow dyeings having very good fastness properties. In the dyeing liquors used in the above applications, the inventive preparations of the dye mixtures should preferably be present in a very fine state of subdivision. The dyes are finely divided by suspending the individual dyes or the dye mixtures together with dispersants in a liquid medium, preferably in water, and exposing the dye mixture to the action of shearing forces. This mechanically comminutes the dye particles originally present to such an extent that an optimum specific surface area is obtained and the sedimentation of the dye is avoided. The particle size of the dyes is generally between 0.1 and 5 μm, preferably between 0.5-1 μm. The dispersants used in the grinding step may be the nonionic or anionic dispersants already mentioned in connection with the production of the dye mixture.

The dye mixtures and preparations of the invention are further particularly useful for dyeing polyester fibers and polyester fiber materials in the alkaline medium at up to pH 10, especially at pH 8 to 9.5. The advantages of this method were mentioned above.

Solid preparations (powder or granular preparations) are preferred for most applications.

A preferred method for producing solid dye compositions is to strip the above-described liquid dye dispersions of the liquid, especially the water, for example by vacuum drying, freeze drying, drying on can dryers, preferably by spray drying.

To prepare the dye mixtures of the invention in finely divided form, the following procedure can be adopted: for example, 10 to 50 parts of a dye mixture are bead milled with 10 to 80 parts of ligninsulfonate, 0 to 20 parts of the condensation product of naphthalenesulfonic acids and formaldehyde, 10 to 0 parts of nonionic dispersant, 0 to 1.5 parts of wetting agent, 0.1 to 1.0 part of defoamer, 0.2 to 1.5 parts of dustproofer with sufficient water for the dispersion to have a solids content of 5 to 60% by weight (parts are by weight).

When solid dye preparations are produced, the drying can be preceded by adding a dustproofer, preferably in an amount of 0.1 to 1.5 parts, to the suspension to be spray dispensed.

The spray drying of a slurry containing the dye mixtures according to the invention is preferably effected in conventional spray dryer at dryer inlet temperatures of 130 to 160° C., preferably 140 to 150° C., and outlet temperatures of 50 to 80° C., preferably 60 to 70° C.

The above-described dye dispersions are very useful for making up print pastes and dyeing liquors.

To prepare dyeing liquors, the requisite amounts of the dye formulations prepared according to the above directions are diluted with the dyeing medium, preferably with water, to such an extent that a liquor ratio of 5:1 to 50:1 results for the dyeing. The liquors are generally additionally admixed with further dyeing assistants, such as dispersing, wetting and fixing aids.

When the dye mixture is to be used for textile printing, the requisite amounts of the dye formulations are kneaded together with thickeners, for example alkali metal alginates or the like, and optionally further additives, for example fixation accelerants, wetting agents and oxidizing agents, to form print pastes.

The printing of the materials mentioned can be carried out in a conventional manner by incorporating the dye mixtures of the invention into a print paste and treating the material printed therewith at temperatures between 180 to 230° C. with HT steam or drying heat to fix the dye, optionally in the presence of a carrier.

This provides very strong greenish yellow dyeings and prints having very good fastnesses, especially very good fastness to light, crocking, dry heat setting and pleating, water and thermomigration. Very deep shades are possible too.

The dye mixtures of the invention are also useful for dyeing the above-recited hydrophobic materials from organic solvents by the methods known for this purpose and for mass coloration.

The examples which follow illustrate the invention.

All % ages are by weight, unless otherwise stated.

### EXAMPLE 1

1.6 g of the azo dye of the formula III and 0.4 g of the quinophthalone of the formula IV (Disperse Yellow 160) are intimately mixed in a mortar.

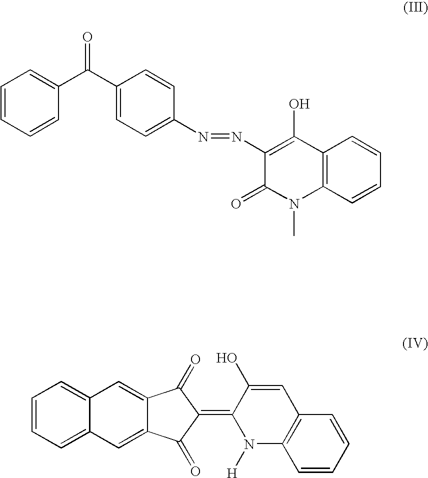

0.25 g of this mixture is dissolved in 10 ml of DMF in the heat, 1 ml of a dispersant is added, and the solution is made up with water to 300 ml. The pH is adjusted to 4.5 with a buffer solution. The dyeing liquor thus obtained is used to dye 100 g of a polyethylene glycol terephthalate fabric in an autoclave at 130° C. for 60 min. On reduction clearing a greenish yellow dyeing having excellent fastnesses is obtained.

When this dyeing is repeated at pH 9 by means of an appropriate buffer solution, a dyeing which is virtually identical in depth of shade and hue is obtained.

### EXAMPLE 2

1.6 g of the azo dye of the formula (III) and 0.4 g of the quinophthalone of the formula V (Disperse Yellow 64) are intimately mixed in a mortar.

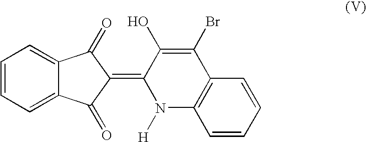

A dyeing process as in example 1 with 0.25 g of this mixture provides a greenish yellow dyeing having excellent fastnesses.

When this dyeing is repeated at pH 9 by means of an appropriate buffer solution, a dyeing which is virtually identical in depth of shade and hue is obtained.

### EXAMPLE 3

1.4 g of the azo dye of the formula (VI) and 0.6 g of the quinophthalone of the formula (IV) (Disperse Yellow 160) are intimately mixed in a mortar.

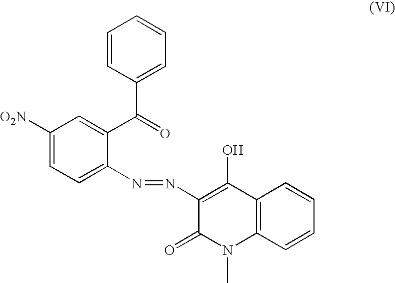

A dyeing process as in example 1 with 0.27 g of this mixture provides a greenish yellow dyeing having excellent fastnesses.

When this dyeing is repeated at pH 9 by means of an appropriate buffer solution, a dyeing which is virtually identical in depth of shade and hue is obtained.

The mixtures reported in the table which follows, when applied by the method of example 1, likewise provide very fast greenish yellow dyeings on polyester, the same results being obtained at pH 9 as at pH 4.5.

| | |
|---|---|
| Fraction | Fraction |

| Example | R¹ | R² | R³ | X | A | of I in % | of II in % |
|---|---|---|---|---|---|---|---|
| 4 | PhCO— | H | Me | H | 2,3-anellated naphthalene | 70 | 30 |
| 5 | PhCO— | H | Me | H | 2,3-anellated naphthalene | 60 | 40 |
| 6 | PhCO— | H | Me | H | 2,3-anellated naphthalene | 50 | 50 |
| 7 | PhCO— | H | Me | Br | benzene | 70 | 30 |
| 8 | PhCO— | H | Me | Br | benzene | 50 | 50 |
| 9 | NO₂ | PhCO— | Me | Br | benzene | 70 | 30 |

What is claimed is:

1. A disperse dye mixture containing at least one hydroxyquinolone monoazo dye of the formula (I) or its tautomeric forms, 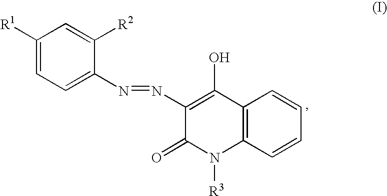
where either
R¹ is PhCO—, in which case the phenyl ring may be substituted by one or more identical or different substituents selected from the group consisting of lower alkyl and halogen, and
R² is hydrogen,
or
R¹ is NO₂ and
R² is PhCO—, in which case the phenyl ring may be substituted by one or more identical or different substituents selected from the group consisting of lower alkyl and halogen, and
R³ is H or methyl
and at least one quinophthalone dye conforming to the formula (II) or its tautomeric forms 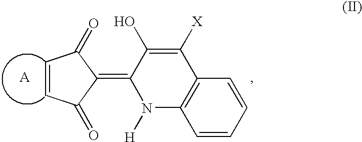
where
X is H or Br and
A is an anellated benzene ring, which may be substituted by lower alkyl or by halogen, or is an anellated naphthalene ring.

2. Mixtures as claimed in claim 1, wherein the amount of quinophthalones (II) in the mixture is 10 to 90% by weight.

3. A dye mixture as claimed in claims 1 and 2, containing at least one disperse dye selected from the group consisting of C.I. Disperse Blue 56, C.I. Disperse Blue 156 and C.I. Disperse Blue 367.

4. A dye preparation containing
10-60% by weight of dye mixture as claimed in at least one of claims 1 to 3
10-80% by weight of anionic dispersant
0-15% by weight of nonionic dispersant and optionally further additives such as wetting agents, defoamers, dustproofers and also further assistants.

5. Use of dye mixtures as claimed in at least one of claims 1 to 3 and dye preparations as claimed in claim 4 for dyeing and printing hydrophobic synthetic materials.

6. Use as claimed in claim 5, wherein dyeing is carried out at a pH of 8 to 10.
